(19) United States
(12) Patent Application Publication
(10) Pub. No.: US 2007/0183257 A1
(43) Pub. Date: Aug. 9, 2007

(54) Submersibly operable high volume and low pressure liquid transfer equipment

(76) Inventor: Zacharias Joseph Van Den Berg, Glenharve (ZA)

Correspondence Address: WYATT, TARRANT & COMBS, LLP, 1715 AARON BRENNER DRIVE, SUITE 800, MEMPHIS, TN, 38120-4367, US

(21) Appl. No.: 10/582,287

(22) PCT Filed: Dec. 10, 2004
(86) PCT No.: PCT/ZA04/00155

§ 371 Date: Jan. 11, 2007

(30) Foreign Application Priority Data
Dec. 10, 2003 (ZA) 2003/9329

(51) Int. Cl. B01F 5/12

(52) U.S. Cl. 366/264

(57) ABSTRACT

Submersibly installable and operable high volume and low pressure stirrer type liquid transferring equipment (10) comprises a rotor type stirrer (12) driven via a drive shaft (16) passing without making contact along a sleeve (18) rooting centrally in a housing (14) having a downwardly facing inlet (22) and a tangentially arranged outlet (24). As the casing (26) of the housing (14) is independent of the remainder of the equipment (10) it is fitted with elevating leg plates (30). Its operative location is accommodated by a location of equipment installation. The stirrer (12) is bolted to a drive assembly (36) via its shaft (16). The length of the sleeve (18) is established in conjunction with the circumstances of use of the equipment (10) to maintain the zone (2) encompassed by the housing (14) sealed from above by a liquid seal.

### (2) BACKGROUND TO THE INVENTION

Conditions are often encountered where a large volume of liquid is desired to be recirculated and/or transferred against a small head such as the passing of sludge and liquid through a sewage plant. As it is desirable to retain the power consumption in achieving such transfer and circulation to as low a rate as possible it is, amongst others, an object of this invention to address this aspect.

### (3) PRIOR ART DESCRIPTION

The transfer and recirculation of liquid in a sewage treatment plant is achieved by way of conventional pumping equipment of which the normal function is to transfer liquid against a large head. The use of such equipment even if used under conditions of transferring against a small head consumes substantial power.

### (4) FIELD OF THE INVENTION

This invention relates to a submersibly operable high volume and low pressure liquid transfer facility and to a layout and installation involving its use. Although not so in any way so limited the invention is usefully applicable in the case of sewage treatment.

### (5) BRIEF DESCRIPTION OF THE DRAWING

In the drawings:

FIG. 1 shows in partly cut away side elevation a submersibly operable high volume and low pressure liquid transfer facility, according to one aspect of the invention, in the form of stirrer type transferring equipment, as installed,

FIG. 2 shows the equipment in plan view along section line A-A in FIG. 1,

FIG. 3 shows the equipment from below,

FIG. 4 shows in partly cut away side elevation the equipment of FIGS. 1 to 3 as supplemented to provide for the intake of liquid from a source of which the liquid level is at a lower level than that housing the equipment,

FIG. 5 shows in diagrammatic side elevation a liquid recirculation and transfer layout, according to another aspect of the invention, involving equipment in accordance with the FIGS. 1 to 3 embodiment of the invention,

FIG. 6 shows the central part of the layout in plan view,

FIG. 7 shows in diagrammatic side elevation the liquid recirculation and transfer layout involving equipment in accordance with the FIG. 4 embodiment of the invention,

FIG. 8 shows in diagrammatic side elevation the layout of FIGS. 5 and 6 when arranged and supplemented as a water treatment installation,

FIG. 9 shows the water treatment installation of FIG. 8 in plan view, and

FIG. 10 shows a flow diagram of a water treatment procedure making use of the installation of FIGS. 8 and 9.

### (6) DETAILED DESCRIPTION OF THE DRAWINGS

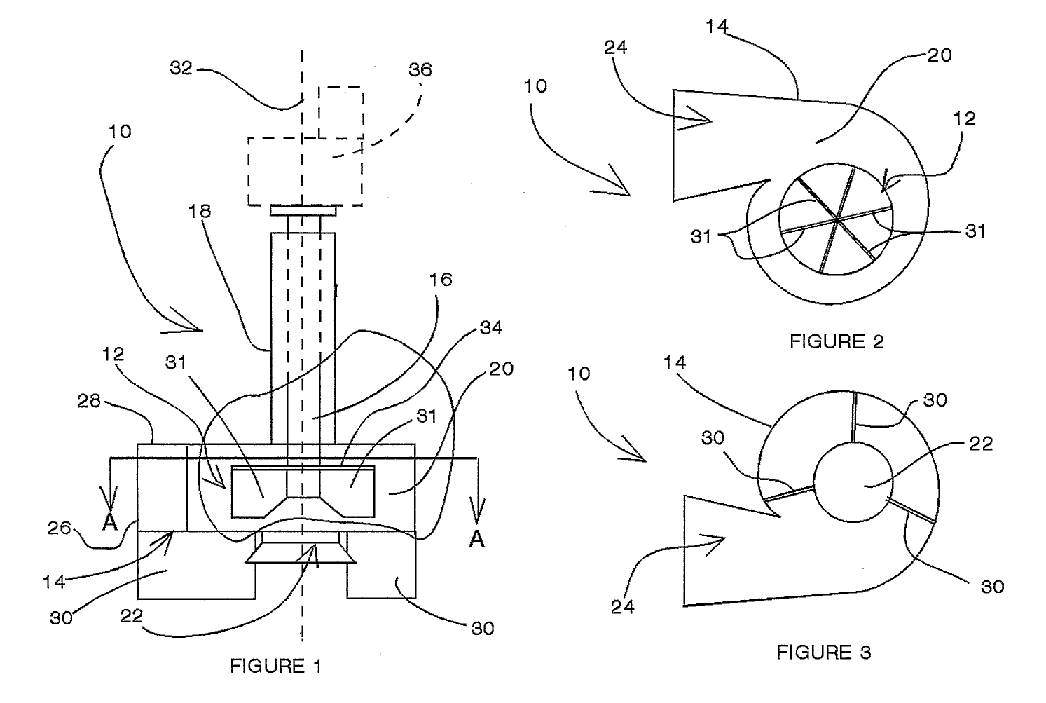

Referring to FIGS. 1 to 4 of the drawings a submersibly operable high volume and low pressure liquid transfer facility in the form of stirrer type transferring equipment is generally indicated by reference numeral 10.

The equipment 10 comprises a rotor type stirrer 12 situated to freely rotate in a horizontal plane within a housing 14, once the equipment 10 is operatively installed, via an upright stirrer drive shaft 16 as passing along an upwardly extending enclosure in the form of a sleeve 18 rooting centrally in the housing 14. The housing 14 thus defines a liquid transfer zone 20 extending between a downwardly facing axially arranged inlet 22 and a tangentially arranged outlet 24. The zone 20 extends in a liquid flow promoting way owing to the housing 14 being generally formed like the housing of a centrifugal pump.

The housing is constituted from a casing 26 fitted with a releasable upper cover 28 that is integrally formed with the sleeve 18. The sleeve 18 thus extends above the housing 14 once the equipment 10 is operatively installed rendering the zone 20 open from above.

The casing 26 is independent from the stirrer 12 and the cover 28. To accommodate the inlet 22 to the zone 20 the casing 26 is fitted with elevating means in the form of leg plates 30 extending radially between the periphery of the housing 14 and the edge of the inlet 22.

The stirrer 12 is formed with stirrer blades 31 that are regularly arranged about its axis of rotation 32. The blades 31 are integrally mounted to a blade carrier 34 from the remote side of which the shaft 16 extends. The stirrer 12 is rotatably driven from a drive in the form of an overhead mounted gearbox and motor assembly 36 that does not necessarily form part of the equipment 10 and that is selected for driving the stirrer 12 at a conventional stirrer type speed of rotation. As the stirrer 12 is freely suspended within the housing 14 it is so operatively maintained by being bolted to the drive assembly 36 via its shaft 16.

The height of the sleeve 18 is established in conjunction with the circumstance of use of the equipment 10 to maintain the zone 20 sealed from above by a liquid seal while the shaft 16 and stirrer 12 runs without in any way making contact with the sleeve 18 or the housing 14.

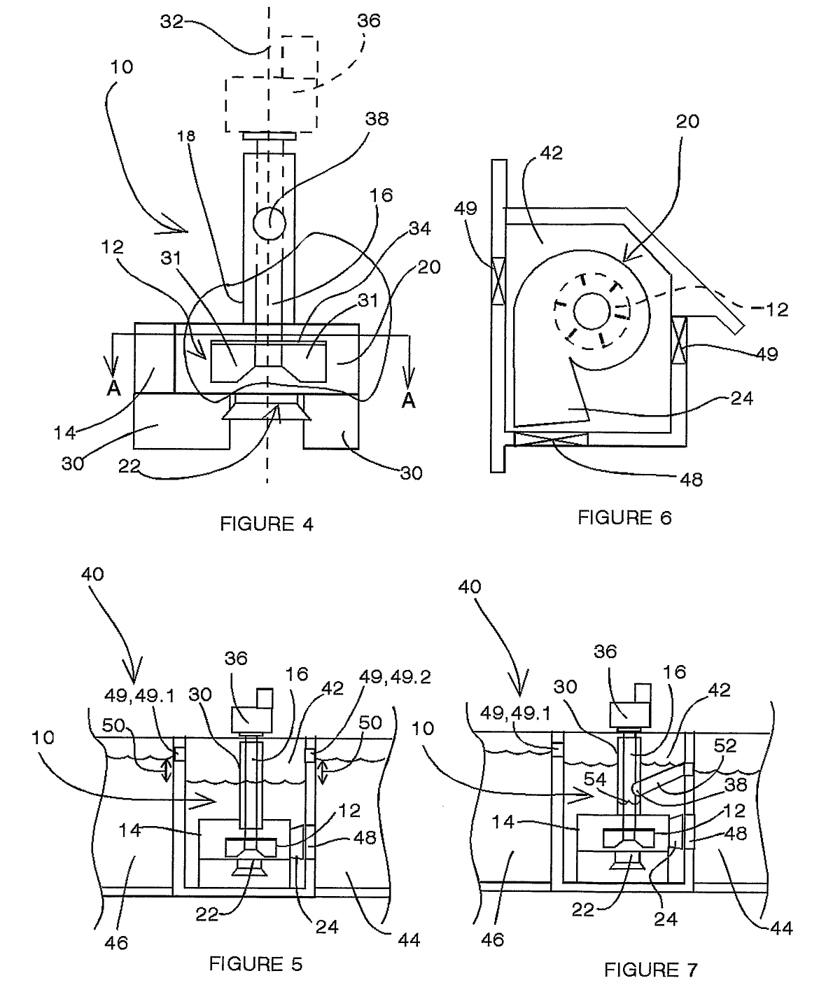

Referring also to FIG. 4 the sleeve 18 presents a charging pipe connection 38 to which an equipment charging pipe (not shown) is sealably connectable by being boltable thereto for charging the zone 20 from a position along the sleeve 18. The location of the connection 38 along the sleeve 18 is pre-established under conditions of use of the equipment 10 to the effect of gravitationally charging the zone 20 from a source of which the liquid level is lower than that of the vessel in which the equipment 10 is positioned but still above the elevation of liquid in the sleeve 18 once the equipment 10 is in operation. This effect is naturally brought about by suction action of the stirrer 12 on the liquid column in the sleeve 18.

Referring also to FIGS. 5 to 7 the equipment 10, as of high volume and low-pressure characteristics, is thus installable for re-circulating liquid in a liquid recirculation and transfer vessel layout generally indicated by reference numeral 40. The layout 40 comprises a liquid transfer facility holding vessel in the form of an equipment holding vessel 42, a re-circulation vessel 44 and a recirculation-cum-charging vessel 46.

Although not shown the casing 26 is installed by way of anchoring guides extending upward from the floor of the vessel 42 that promote the ease of retraction of the equipment 10 by simply lifting it away.

As more clearly shown in FIG. 6 the equipment 10 is naturally installed with its outlet 24 facing an equipment holding vessel discharge in the form of a discharge port 48 situated at a low level while its inlet 22 faces downward. The vessels 42, 44 and 46 are interconnected by high elevation charging ports 49 permitting the gravitational return flow or charging of liquid to the vessel 42. While not shown the size of the ports 49 are controllable by sluice gates.

The object of the layout 40 is to transfer liquid against a small head inclusive of a circulatory transfer between the vessels 42 and 44, 46. As operation of the equipment 10 has the effect of drawing the level in the vessel 42 below that of the levels in the vessels 44, 46, as shown in FIG. 5, a positive hydrostatic head 50 is created in the direction of the vessel 42. This causes liquid to continuously flow from the vessels 44, 46 to the vessel 42 via the ports 49 once the equipment 10 is running. In practice the layout 40 will normally be used in a continuous process. To this effect the vessel 42 can either be charged from a pipe (not shown) or the vessel 46 can be a charging vessel. In either case the various levels will automatically stabilise once the vessel layout 40 is running. Under such stabilised running conditions fresh liquid will continuously gravitate from the vessel 46 via its charging port 49.1 to the vessel 42 while continuous recycling of liquid will take place between the vessels 44 and 42 via the port 49.2. A flow equal to the charging will naturally be discharged from the vessel 44 via its discharge (not shown).

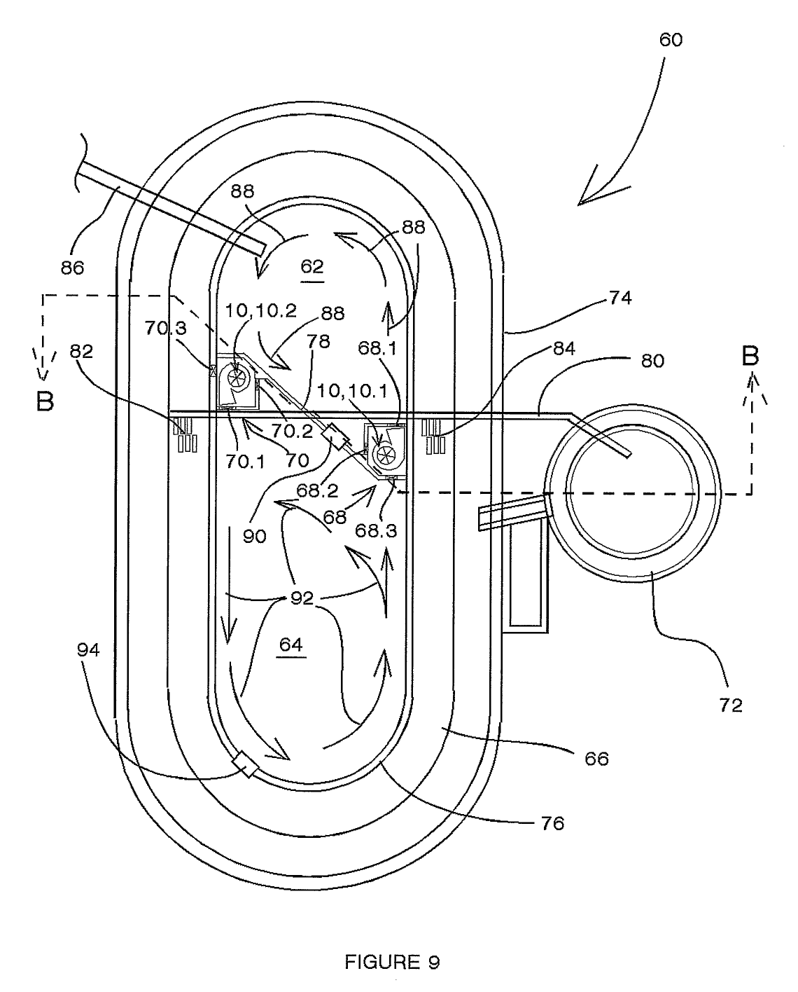

In referring to FIG. 7 in conjunction with FIG. 4 in case where the FIG. 4 embodiment of the equipment 10 is used the vessel 44 and even the vessel 46 (not shown) can be in flow communication with the vessel 42 via a pipe 52 that is connected to the connection 38 of the sleeve 18. The inlet to the pipe 52 is at a high elevation to the vessel 44 that is however below the operating level of liquid in the vessel 42. The outlet from the pipe 52 is however above the liquid level 54 in the sleeve 18 under conditions of operation of the layout 40 as already discussed. This has the effect that liquid can still gravitate from the vessel 44 to the vessel 42 despite having a lower liquid level. Except for the flow conditions created by the pipe 52 the operation of the FIG. 7 embodiment of the layout 40 is similar to that of the FIGS. 5 and 6 embodiment. It will appreciated that the location of the pipe connection 38 must be established under the conditions of use of the layout 40.

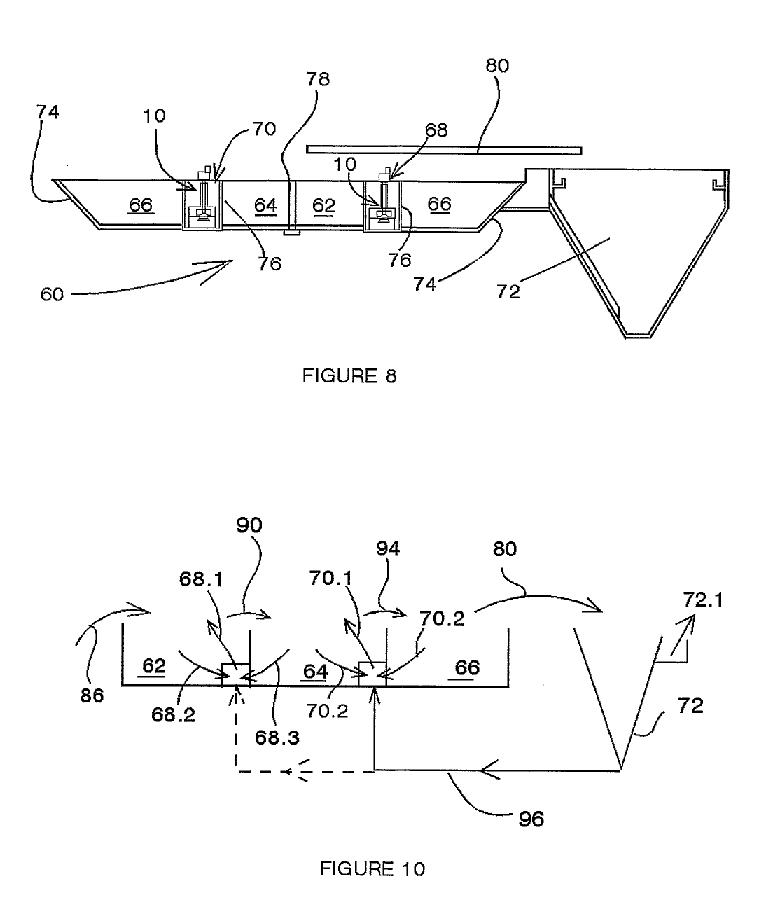

In further referring to FIGS. 8 to 10 the layout 40 is usefully employable under conditions of water treatment and especially the treatment of sewage.

A sewage treatment installation 60 is constituted from a primary treatment vessel 62, an intermediate treatment vessel 64, a discharge vessel in the form of a final treatment vessel 66, a pair of equipment holding vessels in the form of equipment holding sumps 68, 70 and a separator vessel 72. In this vessel layout the sumps 68, 70 concur with the equipment holding vessel 42 of FIGS. 5 and 6 and the vessels 62, 64 and 66 with the vessels 44, 46.

The installation 60 presents a generally oval structure having a peripheral outer wall 74, and an inner wall 76 spaced inwardly there from between which walls 74, 76 the vessel 66 is defined. A transverse wall 78 extends obliquely across the oval formation defined within the inner wall 76 dividing it into the vessels 62 and 64. The equipment 10 contained by the sumps 68, 70 connects discharge fashion with each vessel 62 and 64 respectively. The sumps 68, 70 have outlet ports 68.1,70.1 and adjustable inlet ports in the form of first adjustable inlet sluices 68.2, 70.2 and second adjustable inlet sluices 68.3, 70.3 for varying the flow rates of liquid into the sumps 68,70. The sumps 68 and 70 are small in volume in comparison with their associated reactor vessels 62 and 64.

Adjustment of the gates of the sluices 68.2, 68.3 and 70.2 and 70.3 and operation of the equipment 10 result in a lowering in the level of liquid in the sumps 68, 70 causing positive hydrostatic liquid heads between the liquid in the primary and intermediate treatment vessels 62 and 64 and the sump 68, on the one hand, and between the intermediate and final treatment vessels 64 and 66 and the sump 70 on the other hand. The hydrostatic heads causes liquid to flow from the vessel 62 though the inlet-sluice 68.2 into the sump 68 and from the vessel 64 though the inlet-sluice 70.2 into the sump 70 respectively. The equipment 10 in each sump 68, 70 returns liquid through the respective outlet ports 68.1, 70.1 into the vessels 62 and 64 respectively again in a circulatory manner thereby providing a mixing liquid flow stream. In addition liquid from the vessel 64 can be permitted to flow to the sump 68 via the sluice 68.3 and from the vessel 66 to the sump 70 via the sluice 70.3 to expand the circulatory effect.

To promote a flow of liquid from the vessel 62 to the vessel 64 the gates of the sluices 68.2, 70.2, 68.3, 70.3 are appropriately adjusted. While not specifically described under this embodiment the FIG. 7 layout can be usefully employed for maintaining a return flow of liquid from the vessel 64 to the vessel 62 via the sluice 68.3 even though the level of liquid in the vessel 64 is lower than that in the sump 68 during operation of the installation 60. The same applies for a flow between the vessel 66 and the vessel 64 via the sump 70.

The installation 60 further includes an elevated launder 80 fed by aerators 82 and 84 dipping into the surface of the liquid in the vessel 66. The aerators 82, 84 thereby raise liquid and sludge into the launder 80 which then conveys such liquid and sludge and discharges it into the separator vessel 72.

In using the installation 60 as sewage treatment plant a primary treatment zone is defined within the vessel 62, a secondary treatment zone within the vessel 64 and a tertiary treatment zone within the vessel 66. Anaerobic treatment takes place in vessel 62, anoxic treatment in vessel 64 and aerobic treatment in vessel 66. It will be appreciated that the specific physical installation may be used or adapted to suit the treatment protocol required.

In use, raw liquor to be treated is fed into the primary treatment vessel 62 via inlet pipe 86. The equipment 10 in the sump 68 displaces liquid from the sump 68 via the outlet port 68.1, in the direction of arrows 88 within the reactor vessel 62, thereby to mix the contents of the first treatment zone. The liquid is returned to the sump 68, via the adjustable sluice 68.2, for recirculation. Treated liquid flows from the first treatment vessel 62 into the second treatment vessel 64 via an overflow 90. Recycled liquid from the vessel 64 can also pass into the sump 68 via the port 68.3 for transfer into the vessel 62.

Similarly the equipment 10 of the sump 70 displaces liquid from the sump 70 via the outlet port 70.1 in the direction of the arrows 92 in the vessel 64, thereby to mix the contents of the secondary treatment zone. The liquid is returned to the sump 70 via the adjustable inlet sluice 70.2 for recirculation. Treated liquid flows from the vessel 64 into the vessel 66 via an overflow 94. Recycled liquid from the vessel 66 can also pass into the sump 70 via the inlet port 70.3 for transfer into the vessel 64.

By suitably adjusting the gates controlling the flow through the various ports, it is possible to obtain various levels of liquid within the various treatment zones and thereby obtaining variation in the degree of circulation within the zones, and recirculation and transfer of liquid between various zones.

Clarified liquid overflows from the separator vessel 72 as indicated by arrow 72.1 shown in FIG. 10. Sludge may be recirculated if desired, from the bottom of the vessel 72, along the flow conduit 96 to the sumps 62 and 64.

While the installation 60 is described with the reference to the equipment of FIGS. 5 and 6 it will be appreciated that the FIG. 4 embodiment of the equipment and thus FIG. 7 embodiment of the layout 40 can equally be used with the necessary adjustments.

It is an advantage of the aspect of the invention in the form of the equipment 10 as specifically described that a relatively large volumetric flow of liquid though at a low pressure is achievable by means of stirrer type equipment that require very little maintenance and run at a low consumption of power. The advantages brought about by the device 10 are thus usefully applicable under appropriate systems such as in sewage treatment plants.

1. A submersibly operable high volume and low pressure liquid transfer facility (10) employable for amongst others the gravitational recirculation of liquid between vessels comprising
a rotor type stirrer (12) at least connectable to an overhead drive (36) suitable to rotate it at a conventional stirrer type speed of rotation,
a stirrer housing (14) within which the stirrer (12) is freely rotatably mounted, at least once the facility (10) is ready for use, defining a liquid transfer zone (20) extending in a liquid flow promoting way between a liquid intake (22) and a tangential liquid discharge (24),
characterised in that the liquid intake (22) to the housing (14) is situated to be non-overhead while the stirrer (12) is mounted to rotate in a horizontal plane and thus about an upright axis (32) at least once the facility (10) is so ready for use.

2. A liquid transfer facility as claimed in claim 1 in which the stirrer (12) incorporates a blade carrier (34) via which it is drivable that is fitted with a plurality of regularly circumferentially arranged radially extending liquid transfer blades (31).

3. A liquid transfer facility as claimed in claim 1 or claim 2 in which the housing (14) permits for its removal from its location of operative use.

4. A liquid transfer facility as claimed in claim 3 in which at least part of the housing (14) though to the effect of enabling stirrer location there into from above, is independent of the remainder of the facility (10) thus being independently installable with its location of installation providing for its positioning against displacement.

5. A liquid transfer facility as claimed in any one of the preceding claims of which the intake (22) to its housing (14), as operatively viewed, is from below under which circumstance the housing (14) is thus elevated above the floor of a vessel within which the facility is submersed, the intake (22) in the case of the stirrer being of smaller cross sectional area than the peripheral skirting of the wall of the housing (14) being axially arranged as regards the axis of rotation (32) of the stirrer (12) while the housing, when at least partly independently installable, incorporating elevating means (30) for elevating it above the floor of its location of installation.

6. A liquid transfer facility as claimed in any one of the preceding claims that is constituted to result in the housing (14) being open to the environment under circumstances of use by way of an open ended upwardly extending enclosure (18) rooting in the housing and of which the length is determinable in conjunction with the circumstance of use of the facility to the effect of maintaining the housing (14) sealed from above by way of a liquid seal despite the enclosure (18) being open to the environment with the enclosure extending suitably to also house the drive shaft (16) of the stirrer (12), as thus couplable to and independently rotatably suspensible from a non-submersible drive (36), against enclosure catching, the housing when removable while at least part is independent of the remainder of the facility, as thus in the form of an installation, while the enclosure (18) is of lesser diameter than the sweep of the stirrer (12), being constituted from a casing (26), as installable to a location of use, and a cover (34) from which the enclosure (18) extends to enable installation of the stirrer to the housing.

7. A liquid transfer facility as claimed in claim 6 in which the enclosure is in the form of a rotor shaft encompassing sleeve (18) rooting centrally into the upper wall of the housing (14) at least once the facility is ready for use, of which sleeve (18) the diameter is established under conditions of use to the effect of ensuring that the level of liquid therein, though lower than that outside the sleeve (18), remains above the housing to limit the possibility of the suction of air into the housing (14) via the sleeve (18) during operation of the facility.

8. A liquid transfer facility as claimed in claim 7 that provides for connection (38) of a charging pipe (52) to the sleeve (18) at a position above the liquid level therein though below the outside liquid level of a facility holding vessel, as established under conditions of use of the facility (10), thereby enabling the gravitational transfer of liquid from another vessel of lower liquid level that within which the facility (10) is housed though still above the level of liquid within the sleeve (18).

9. A liquid recirculation and transfer vessel layout (40, 60) also employable for the treating of liquid comprising
a liquid transfer facility holding vessel (42) submersibly holding a high volume and low pressure liquid transfer facility (10) that comprises a rotor type stirrer (12) mounted to rotate in a horizontal plane and connected to an overhead drive (36) suitable to rotate it at a conventional stirrer type speed of rotation and a stirrer housing (14) of which the liquid intake (22) is non-overhead and within which the stirrer (12) is freely rotatably mounted while defining a liquid transfer zone (20) extending in a liquid flow promoting way between a liquid intake (22) mouthing in the a liquid transfer facility holding vessel (42) and a tangential liquid discharge (24), and
a recirculation vessel (44) into which the liquid transfer facility (10) is arranged to discharge via a low elevation discharge port (48) owing to its discharge (24) being in adequate close vicinity of the port if not registering with it while provision is made for the gravitational return flow of liquid from the recirculation vessel (44) to the liquid transfer facility holding vessel (42) and to and from at least one of which vessels liquid required for treatment is conventionally chargable and treated liquid is removable.

10. A liquid recirculation and transfer layout as claimed in claim 9 in which the stirrer (12) of the transfer facility (10) incorporates a blade carrier (34) via which it is drivable that is fitted with a plurality of regularly circumferentially arranged radially extending liquid transfer blades (31).

11. A liquid recirculation and transfer layout as claimed in claim 9 or claim 10 in which the housing (14) of the transfer facility (10) permits for its removal from the liquid transfer facility holding vessel (42).

12. A liquid recirculation and transfer layout as claimed in claim 11 in which at least part of the housing (14) of the transfer facility (10) though to the effect of having enabled stirrer location there into from above, is independent of the remainder of the facility thus being independently installed against displacement to the liquid transfer facility holding vessel (42) as so accommodating it.

13. A liquid recirculation and transfer layout as claimed in any one of claims 9 to 12 of which the intake (22) to the housing (14) of the transfer facility (10) is from below with the housing thus being elevated above the floor of the transfer facility holding vessel (42), the intake (22) in the case of the stirrer (12) being of smaller cross sectional area than the peripheral skirting of the wall of the housing (14) being axially arranged as regards the axis of rotation (32) of the stirrer (12) while the housing (14), when at least partly independently installable, incorporating elevating means (30) that elevates it above the floor of the of the transfer facility housing vessel (42).

14. A liquid recirculation and transfer layout as claimed in any one of claims 9 to 13 in which the liquid transfer facility (10) is constituted to result in the housing (20) being open to the environment by way of an open ended upwardly extending enclosure (18) rooting in the housing and of which the length has been determined in conjunction with the circumstance of use of the facility (10) to the effect of maintaining the housing (14) sealed from above by way of a liquid seal despite the enclosure (18) being open to the environment with the enclosure extending suitably to also house the drive shaft (16) of the stirrer (12), as thus coupled to and independently rotatably suspended from a non-submersible drive (36), against enclosure catching, the housing (14) when removable while at least part is independent of the remainder of the facility, as thus in the form of an installation, while the enclosure (18) is of lesser diameter than the sweep of the stirrer (12), being constituted from a casing (26) as installed to the transfer facility holding vessel (42) and a cover (34) from which the enclosure (18) extends.

15. A liquid recirculation and transfer layout as claimed in claim 14 in which the enclosure is in the form of a rotor shaft encompassing sleeve (18) rooting centrally into the upper wall of the housing (14) of which the diameter has been established under conditions of use to the effect of ensuring that the level of liquid therein, though lower than that outside the sleeve (18), remains above the housing to limit the possibility of the suction of air into the housing via the sleeve during operation of the layout.

16. A liquid recirculation and transfer layout as claimed in any one of claims 9 to 15 in which the return flow between the recirculating vessel (44) and the liquid transfer facility holding vessel (42) is via a high elevation return flow arrangement (49), return flow resulting from the liquid level in the liquid transfer facility holding vessel (42) being maintained at a lower level than that in the recirculating vessel (44) by the hydrostatic pressure advantage created the operation of the liquid transfer facility (10).

17. A liquid recirculation and transfer layout as claimed in claim 16 in which the high elevation return flow arrangement is in the form of a return flow port (49).

18. A liquid recirculation and transfer layout as claimed in claim 17 in which the size of the port (4) is adjustable by way of an adjusting mechanism.

19. A liquid recirculation and transfer layout as claimed in claim 18 in which the adjusting mechanism is in the form of a sluice mechanism involving a sluice gate.

20. A liquid recirculation and transfer layout as claimed in any one of claims 9 to 15 in which the return flow between the recirculating vessel (44) and the liquid transfer facility holding vessel (42) is achieved via an enclosed conduit (52) extending downward from a high elevation in the recirculating vessel (44) that is, however, below the elevation of liquid in the liquid transfer facility holding vessel (42) once the layout is in use, to a charging pipe connection (38) into the sleeve (18) of the liquid transfer facility (10), as so arranged, that is located at a position above the liquid level therein though below the liquid level of the liquid transfer facility holding vessel (42) as brought about by the suction effect of the stirrer (12) on the liquid level in the sleeve (18) once the layout (40) is in use, thereby enabling the gravitational transfer of liquid from the recirculating vessel (44) even though of lower liquid level than that of the liquid transfer facility holding vessel (42) during operation of the layout with the parameters of operation of the layout having been appropriately pre-established.

21. A liquid recirculation and transfer layout as claimed in claim 20 in which the flow of liquid along the enclosed conduit (52) is adjustable by way of a conduit flow adjusting mechanism.

22. A liquid recirculation and transfer layout as claimed in claim 21 in which the adjusting mechanism is in the form of a sluice mechanism involving a sluice gate.

23. A liquid recirculation and transfer layout (40, 60) as claimed in any one of claims 9 to 22 that includes a discharge vessel (66) to which treated liquid is gravitationally transferable from the recirculating vessel (44, 46, 62, 64) and aerating equipment (84) arranged to remove treated liquid from the discharge vessel (66) in the appropriate case serving as aerobic reactor, the liquid recirculation and transfer layout thus forming part of a sewage purification installation (60) with at least the recirculating vessel (44, 46, 62, 64) also serving as treatment vessel.

24. A liquid recirculation and transfer layout as claimed in claim 23 in which the discharge vessel (66) is also in return flow communication with the treatment vessel (62, 64) via the liquid transfer facility holding vessel (42, 68, 70) in a way similar to the recirculating vessel.

25. A liquid recirculation and transfer layout as claimed in claim 23 or claim 24 in which the charging of untreated water takes place to the recirculating vessel (62, 64) while the liquid transfer facility holding vessel (68, 70) is in the form of a liquid transfer facility holding sump serving mainly a liquid transferring purpose.

26. A liquid recirculation and transfer layout as claimed in claim 25 that includes an intermediate treatment vessel (64) interspaced between the treatment vessel (serving as primary treatment vessel) (62) with which it is in liquid overflow communication and the discharge vessel (66) as in turn in liquid overflow communication with the intermediate treatment vessel (64) that is also served by a liquid transfer facility holding sump (70) similar to the primary treatment vessel liquid transfer facility holding sump (68), serving an intermediate treatment vessel recirculating and transferring purpose.

27. A liquid recirculation and transfer layout as claimed in claim 26 in which the primary treatment vessel facility holding sump (68) is also in gravitational return flow communication with the intermediate treatment vessel (64) in addition to with the primary treatment vessel (62) enabling the use of either the primary or intermediate treatment vessels as anoxic treatment vessel in a sewage treatment process.

28. A liquid recirculation and transfer layout as claimed in any one of claims 23 to 27 that includes separating equipment (72) that is in supply communication with the discharge vessel (66) via a launder (80) that is fed by the aerating equipment (84).

29. A liquid recirculation and transfer layout as claimed in claim 28 in which the bottom product from the separating equipment (72) is in low elevation return flow communication with at least one of the treatment vessels (62, 64, 68).

30. A liquid recirculation and transfer layout as claimed in any one of claims 23 to 29 in which the primary treatment vessel (62) and the intermediate treatment vessel (64) are separated by a common dividing wall (78) while being peripherally surrounded by the discharge vessel (66) as extending annularly with respect to the vessels (62, 64).
